(19) United States
(12) Patent Application Publication
(10) Pub. No.: US 2021/0046938 A1
(43) Pub. Date: Feb. 18, 2021

(54) FLOOD SENSING DEVICE, FLOOD SENSING SYSTEM, AND NON-TRANSITORY COMPUTER-READABLE MEDIUM

(71) Applicant: TOYOTA JIDOSHA KABUSHIKI KAISHA, Toyota-shi (JP)

(72) Inventors: Jun HATTORI, Tokyo-to (JP); Takayuki YAMABE, Nagoya-shi (JP); Kenki UEDA, Tokyo-to (JP); Tetsuya HASHIMOTO, Tokyo-to (JP); Hajime TOJIKI, Tokyo-to (JP); Naoki ISHIHARA, Tokyo-to (JP); Yuta OCHIAI, Yokohama-shi (JP); Hideki KAWAI, Toyko-to (JP)

(73) Assignee: TOYOTA JIDOSHA KABUSHIKI KAISHA, Toyota-shi (JP)

(21) Appl. No.: 16/987,569

(22) Filed: Aug. 7, 2020

(30) Foreign Application Priority Data
Aug. 13, 2019 (JP) 2019-148409

(51) Int. Cl. B60W 40/06; G08G 1/01; G06N 20/00; B60W 40/10; B60W 40/107

(52) U.S. Cl. CPC B60W 40/06; G08G 1/0112; B60W 2555/20; B60W 40/1005; B60W 40/107; G06N 20/00

(57) ABSTRACT

A flooding sensing device, including: an acquisition section configured to acquire vehicle model information and plural items of travel state data related to travel of a vehicle; and a detection section configured to select a vehicle behavior model from plural vehicle behavior models that are derived in advance for each vehicle model, the vehicle behavior model corresponding to the vehicle model information and calculates a physical quantity that changes in accordance with travel by the vehicle, the detection section detects flooding of a road on which the vehicle travels, using the physical quantity, which is predicted based on the selected vehicle behavior model and on the current plurality of items of travel state data acquired by the acquisition section, and using the physical quantity, which is obtained from the current plurality of items of travel state data acquired by the acquisition section.

### CROSS-REFERENCE TO RELATED APPLICATION

This application claims priority under 35 U.S.C. § 119 to Japanese Patent Application No. 2019-148409, filed Aug. 13, 2019, the disclosure of which is incorporated by reference herein.

### BACKGROUND

### Technical Field

The present disclosure relates to a flood sensing device, a flood sensing system, and a non-transitory computer readable medium storing a flood sensing program.

### Related Art

Roads may flood by heavy rainfall or by an influx of rainwater that has fallen elsewhere or the like. As a technique for detecting such flooding of a road, for example, techniques disclosed in Japanese Patent Application Laid-Open (JP-A) No. 2004-341795 and JP-A No. 2012-216103 are proposed.

According to the technology disclosed in JP-A No. 2004-341795, a vehicle is provided with a flood sensor configured to be able to detect the presence of a liquid tangible object, flooding on a road is detected, a detection result is transmitted to a center server, and other vehicles are provided with detour route guidance establishing a route that does not pass through impenetrable flooding.

In the technology disclosed in JP-A No. 2004-341795, rainfall at a position where the vehicle is traveling is predicted based on a wiper speed and an operation time of a wiper of the vehicle, and it is predicted whether or not a travel route will be flooded based on the predicted rainfall from another vehicle.

However, the technique disclosed in JP-A No. 2004-341795 requires a flood sensor. Since the mounting position of the flood sensor is different for each vehicle type, the determination result may be different depending on the vehicle type. In addition, in order to ensure determination results with the same accuracy, there are design constraints.

Further, in the technique disclosed in JP-A No. 2012-216103, not all drivers operate wipers at the same wiper speed even if the amount of rainfall is the same, and there is room for improvement in accurately determining flooding.

### SUMMARY

The present disclosure provides a flood sensing device, a flood sensing system, and a non-transitory computer-readable medium storing a flood sensing program, that may easily and accurately determine flood of a road by using traveling state data of a vehicle.

A first aspect of the present disclosure is a flooding sensing device, including an acquisition section and a detection section. The acquisition section is configured to acquire vehicle model information and plural items of travel state data related to travel of a vehicle. The detection section is configured to select a vehicle behavior model, corresponding to the vehicle model information acquired by the acquisition section from plural vehicle behavior models that are derived in advance for each vehicle model and that calculate a physical quantity that changes in accordance with travel by the vehicle. Further, the detection section detects flooding of a road on which the vehicle travels, using the physical quantity, which is predicted based on the selected vehicle behavior model and on the current plural items of travel state data acquired by the acquisition section, and using the physical quantity, which is obtained from the current plural items of travel state data acquired by the acquisition section.

According to the first aspect of the present disclosure, the acquisition section acquires vehicle model information and plural items of travel state data related to travel of a vehicle. For example, the flooding sensing device may be installed in a vehicle or provided at a location other than the vehicle. When installed in a vehicle, the acquisition section acquires the vehicle model information of the host vehicle and the travel state data of the host vehicle. When the flooding sensing device is provided at a location other than the vehicle, the acquisition section acquires the vehicle model information of a predetermined target vehicle and the travel state data of the predetermined target vehicle.

Further, the detection section selects a vehicle behavior model corresponding to the vehicle model information acquired by the acquisition section from the plural vehicle behavior models that are derived in advance for each vehicle model. The vehicle behavior model is for calculating a physical quantity that changes in accordance with travel by the vehicle. Next, the detection section detects flooding of a road on which the vehicle travels, using the physical quantity, which is predicted based on the selected vehicle behavior model and on the current plural items of travel state data acquired by the acquisition section, and using the physical quantity, which is obtained from the current plural items of travel state data acquired by the acquisition section. Thereby, the first aspect of the present disclosure may sense flooding without using a flood detection sensor.

Further, since the first aspect of the present disclosure predicts a physical quantity using a vehicle behavior model corresponding to the vehicle model information from among vehicle behavior models derived in advance for each vehicle model, flooding sensing is enabled in which prediction fluctuations caused by the vehicle model may be suppressed.

A second aspect of the present disclosure is a flooding sensing device, including an acquisition section and a detection section. The acquisition section is configured to acquire the plural items of travel state data related to travel of a vehicle. The detection section is configured to detect flooding of a road on which the vehicle travels, using a physical quantity, which is predicted based on a vehicle behavior model that is derived in advance in accordance with a vehicle model and that calculates the physical quantity, which changes in accordance with travel by the vehicle, and based on the current plural items of travel state data acquired by the acquisition section, and using the physical quantity, which is obtained from the current plural items of travel state data acquired by the acquisition section.

According to the second aspect of the present disclosure, the acquisition section acquires vehicle model information and plural items of travel state data related to travel of a vehicle. For example, the flooding sensing device may be installed in a vehicle or provided at a location other than the vehicle. When installed in a vehicle, the acquisition section acquires the travel state data of the host vehicle. Further, when the flooding sensing device is provided at a location other than the vehicle, the acquisition section acquires the travel state data of a predetermined target vehicle.

Further, the detection section detects flooding of a road on which the vehicle travels, using a physical quantity, which is predicted based on a vehicle behavior model that is derived in advance in accordance with a vehicle model and that calculates the physical quantity, which changes in accordance with travel by the vehicle, and based on the current plural items of travel state data acquired by the acquisition section, and using the physical quantity, which is obtained from the current plural items of travel state data acquired by the acquisition section. Thereby, the second aspect of the present disclosure may detect flooding without using a flood detection sensor.

Further, since the second aspect of the present disclosure predicts a physical quantity using a vehicle behavior model corresponding to a vehicle model, flooding detection is enabled in which prediction fluctuations caused by the vehicle model may be suppressed.

A third aspect of the present disclosure is a flooding sensing device, including an acquisition section, a derivation section, and a detection section. The acquisition section is configured to acquire plural items of travel state data related to travel from plural vehicles, and vehicle model information. The derivation section is configured to derive a vehicle behavior model for calculating a physical quantity that changes in accordance with travel by the vehicle, for each vehicle model using the plural items of travel state data, acquired in advance from plural vehicles, and using a predetermined learning model. The detection section is configured to detect flooding of a road on which a target vehicle travels, using the physical quantity, which is predicted using the vehicle behavior model for a vehicle model corresponding to the vehicle model information of the monitored vehicle, which is determined in advance from the vehicle behavior model derived by the derivation section, and is predicted using the current plural items of travel state data acquired from the target vehicle, and using the physical quantity, which is obtained from the travel state data acquired from the target vehicle.

According to the third aspect of the present disclosure, the acquisition section acquires plural items of travel state data related to travel from plural vehicles.

The derivation section derives a vehicle behavior model that calculates a physical quantity that changes in accordance with travel by the vehicle, for each vehicle model using the plural items of travel state data, acquired in advance from plural vehicles, and using a predetermined learning model.

Further, the detection section detects flooding of a road on which a target vehicle travels, using the physical quantity, which is predicted using the vehicle behavior model for a vehicle model corresponding to the vehicle model information of the target vehicle, which is determined in advance from the vehicle behavior model derived by the derivation section, and is predicted using the current plural items of travel state data acquired by the acquisition section from the predetermined target vehicle, and using the physical quantity, which is obtained from the travel state data acquired by the acquisition section from the target vehicle. Thereby, the third aspect of the present disclosure may detect flooding without using a flood detection sensor.

Further, since the third aspect of the present disclosure predicts a physical quantity using a vehicle behavior model corresponding to a vehicle model of the target vehicle, prediction fluctuations in flooding detection caused by the vehicle model may be suppressed.

In a fourth aspect of the present disclosure, in the above-described aspects, the vehicle behavior model may be configured by vehicle drive power and by travel resistance including air resistance acting on the vehicle, gradient resistance acting on the vehicle, and rolling resistance acting on the vehicle. As a result, the fourth aspect of the present disclosure may easily and accurately detect flooding of a road using the travel state data of a vehicle.

In a fifth aspect of the present disclosure, in the fourth aspect, the travel resistance may further include acceleration resistance acting on the vehicle.

In a sixth aspect of the present disclosure, in the above-described aspects, the detection section may detect flooding in a case in which a difference between the predicted physical quantity and the physical quantity obtained from the travel state data is equal to or higher than a predetermined threshold value. Thereby, the sixth aspect of the present disclosure may detect flooding without using a flood detection sensor.

In a seventh aspect of the present disclosure, in the above-described aspects, the vehicle behavior model may be derived using a multiple regression equation as a learning model.

In an eighth aspect of the present disclosure, in the above-described aspects, the vehicle behavior model may be derived with vehicle speed, acceleration, or rate of change of acceleration as the physical quantity and using a motion equation.

A ninth aspect of the present disclosure is a flooding sensing system, including a retrieval section, an acquisition section, a derivation section, and a detection section. The retrieval section is configured to retrieve plural items of travel state data related to travel of a vehicle. The acquisition section is configured to acquire the plural items of travel state data retrieved by the retrieval section and vehicle model information from plural vehicles. The derivation section is configured to derive a vehicle behavior model, which calculates a physical quantity that changes in accordance with travel by the vehicle, for each vehicle model using the plural items of travel state data, acquired in advance by the acquisition section from the plural vehicles, and using a predetermined learning model. The detection section is configured to detect flooding of a road on which a target vehicle travels, using the physical quantity, which is predicted using the vehicle behavior model for a vehicle model corresponding to the vehicle model information of the target vehicle, which is determined in advance from the vehicle behavior model derived by the derivation section, and is predicted using the current plural items of travel state data acquired by the acquisition section from the target vehicle, and using the physical quantity, which is obtained from the current travel state data acquired from the target vehicle.

According to the ninth aspect of the present disclosure, the retrieval section retrieves plural items of travel state data related to travel of a vehicle.

The acquisition section acquires the plural items of travel state data retrieved by the retrieval section and vehicle model information from plural vehicles.

The derivation section derives a vehicle behavior model for calculating a physical quantity that changes in accordance with travel by the vehicle, for each vehicle model using the plural items of travel state data, acquired in advance from plural vehicles by the acquisition section, and using a predetermined learning model.

Further, the detection section detects flooding of a road on which a target vehicle travels, using the physical quantity predicted using the vehicle behavior model for a vehicle model, corresponding to the vehicle model information of the target vehicle, which is determined in advance from the vehicle behavior model derived by the derivation section, and is predicted using the current plural items of travel state data acquired by the acquisition section from the predetermined target vehicle, and using the physical quantity, which is obtained from the travel state data acquired by the acquisition section from the target vehicle. Thereby, the ninth aspect of the present disclosure may detect flooding without using a flood detection sensor.

Further, since the ninth aspect of the present disclosure predicts a physical quantity using a vehicle behavior model corresponding to a vehicle model of the target vehicle, flooding detection is enabled in which prediction fluctuations caused by variety of vehicle models may be suppressed.

A tenth aspect of the present disclosure is a non-transitory computer-readable medium storing a flooding sensing program that causes a computer to function as the respective sections of the flooding sensing device of the first to eighth aspects.

According to the above-described aspects, the flooding sensing device, the flooding sensing system, and the non-transitory computer-readable medium storing the flood sensing program of the present disclosure, may easily and accurately determine flooding using vehicle travel state data.

### BRIEF DESCRIPTION OF THE DRAWINGS

Exemplary embodiments will be described in detail based on the following figures, wherein:

FIG. 1 is a block diagram showing a schematic configuration of a flood sensing system according to the present exemplary embodiment;

FIG. 2 is a diagram for explaining an error (flooding) determination using a predicted value and an actually measured value of the vehicle speed;

FIG. 3 is a diagram showing an example of a table in which vehicle types and model coefficients are associated with each other;

FIG. 4 is a flowchart illustrating a flow of processing performed by a central processing section when a vehicle behavior model is derived by machine learning in the flooded area estimation center of the flooded water sensing system according to the present exemplary embodiment;

FIG. 5 is a flowchart illustrating a flow of processing performed by a central processing section when a flood is determined in the flood area estimation center of the flood sensing system according to the present exemplary embodiment;

FIG. 6 is a flowchart illustrating a flow of processing in which a central processing section estimates a flooded area in a flooded area estimation center in the flooded water sensing system according to the present exemplary embodiment;

FIG. 7 is a block diagram showing a configuration a flood sensing system in a case where the flood determination is performed at the side of the information providing device mounted on each vehicle; and

FIG. 8 is a diagram for explaining another example of the vehicle behavior model.

### DETAILED DESCRIPTION

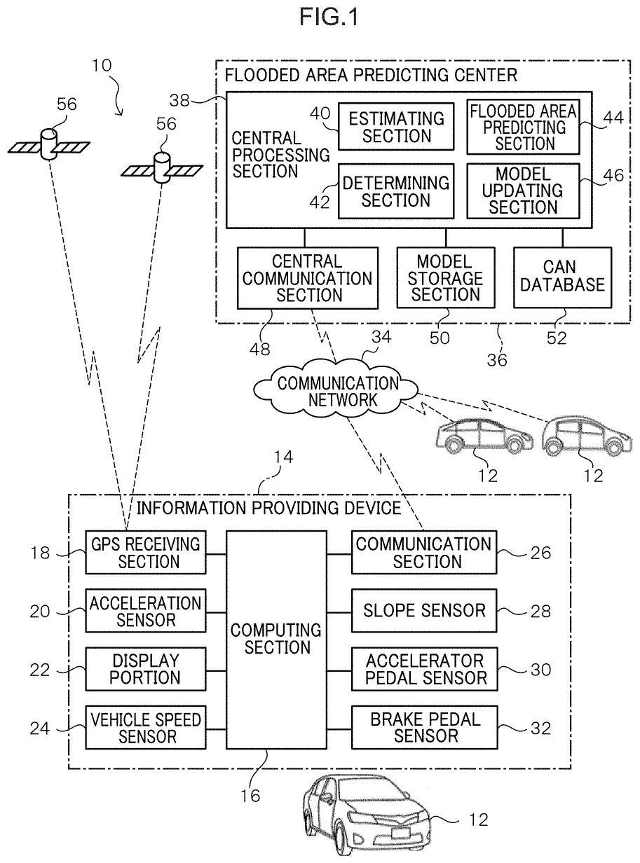

Below, an example of an embodiment of the present disclosure is described in detail with reference to the drawings. FIG. 1 is a block diagram showing a schematic configuration of a flood sensing system according to the present exemplary embodiment.

In the flood sensing system 10 according to the present exemplary embodiment, an information providing device 14 mounted on plural vehicles 12 and a flooded area predicting center 36 are connected via a communication network 34. The flooded area predicting center 36 collects traveling state data of the plural vehicle 12 as CAN (Controller Area Network) data from the information providing devices 14 mounted on the plural vehicles 12. Then, using the collected CAN data, a process of determining the flooding of the roads on which each vehicle 12 is traveling is performed. Further, the flooded area predicting center 36 performs a process of predicting the flooded area using the result of the flood determination of the roads on which each vehicle 12 is traveling.

The information providing device 14 mounted on each vehicle 12 includes a calculation section 16, a GPS receiving section 18, an acceleration sensor 20, a display portion 22, a vehicle speed sensor 24, a communication section 26, a slope sensor 28, an accelerator pedal sensor 30, and a brake pedal sensor 32. Note that the acceleration sensor 20, the vehicle speed sensor 24, the slope sensor 28, the accelerator pedal sensor 30, and the brake pedal sensor 32 correspond to a detection section.

The computing section 16 is configured by a general microcomputer including a CPU (Central Processing Section), a ROM (Read Only Memory), a RAM (Random Access Memory), and the like.

The GPS receiving section 18 receives a signal from a GPS (Global Positioning System) satellite and outputs the received GPS signal to the computing section 16. Thereby, the computing section 16 measures the position of the vehicle 12 based on GPS signals from plural GPS satellites.

The acceleration sensor 20 detects acceleration applied to the host vehicle 12 as traveling state data, and outputs a detection result to the computing section 16. As the acceleration, each of the longitudinal direction, the width direction, and the vertical direction of the vehicle 12 may be detected, or only the longitudinal acceleration of the vehicle 12 may be detected.

The display portion 22 displays information (for example, map information) of the flooded area predicted by the flooded area prediction center 36 and various kinds of information.

The vehicle speed sensor 24 detects the traveling speed of the host vehicle 12 as traveling state data, and outputs a detection result to the computing section 16.

The communication section 26 communicates with the flooding area prediction center 36 and the information providing device 14 mounted on another vehicle 12 by performing wireless communication with the communication network 34. The communication network 34 includes, for example, a wireless communication network such as a mobile phone network.

The slope sensor 28 detects the slope of travel of the vehicle 12 as traveling state data by detecting the inclination of the vehicle 12, and outputs the detection result to the computing section 16. As the slope, only the slope in the front-rear direction of the vehicle 12 may be detected, or the slope in the vehicle width direction may be additionally detected.

The accelerator pedal sensor 30 detects the amount of depression of the accelerator pedal as traveling state data, and outputs a detection result to the computing section 16.

The brake pedal sensor 32 detects an operation state of the brake pedal as traveling state data, and outputs a detection result to the computing section 16.

In the present exemplary embodiment, an example will be described in which the detection results of the acceleration sensor 20, the vehicle speed sensor 24, the slope sensor 28, the accelerator pedal sensor 30, and the brake pedal sensor 32 are detected as travel state data, but the described invention is not limited to this example.

The computing section 16 transmits the plural types of traveling state data acquired from each sensor and the vehicle type ID for identifying the vehicle type to the flooded area prediction center 36 via the communication section 26 and the communication network 34.

The flooded area prediction center 36 includes a central processing section 38, a central communication section 48, a model storage section 50, and a CAN database 52.

The central communication section 48 communicates with the information providing device 14 mounted on each vehicle 12 by performing wireless communication with the communication network 34.

The model storage section 50 stores a vehicle behavior model for obtaining a physical quantity that changes as the vehicle 12 travels, and a coefficient table set for each vehicle type.

The CAN database 52 stores running state data acquired from the information providing device 14 mounted on each vehicle 12 as CAN data.

The central processing section 38 is configured as a general computer including a CPU (Central Processing Section), a ROM (Read Only Memory), a RAM (Random Access Memory), and the like. The central processing section 38 has functions of a estimating section 40, a determining section 42, a flooded area prediction section 44, and a model updating section 46. Each function is realized by executing a program stored in a ROM or the like. Note that the respective functions of the central processing section 38 correspond to an acquisition section, a derivation section, a detection section, a result collection section, and an estimation section, and correspond to processing described later in detail.

The estimating section 40 reads the vehicle behavior model stored in advance in the model storage section 50, specifies the vehicle type from the vehicle type ID, selects a coefficient corresponding to the vehicle type, and applies the selected coefficient to the vehicle behavior model, thereby deriving a vehicle behavior model for each vehicle type. Then, a predicted value of the physical quantity is calculated by substituting the CAN data into the derived vehicle behavior model. In the present exemplary embodiment, a vehicle speed is applied as a physical quantity to be predicted, and a predicted value of the vehicle speed is calculated by applying a previously obtained coefficient corresponding to the vehicle type to a vehicle behavior model derived in advance to obtain the vehicle speed. The details of the vehicle behavior model for obtaining the vehicle speed will be described later.

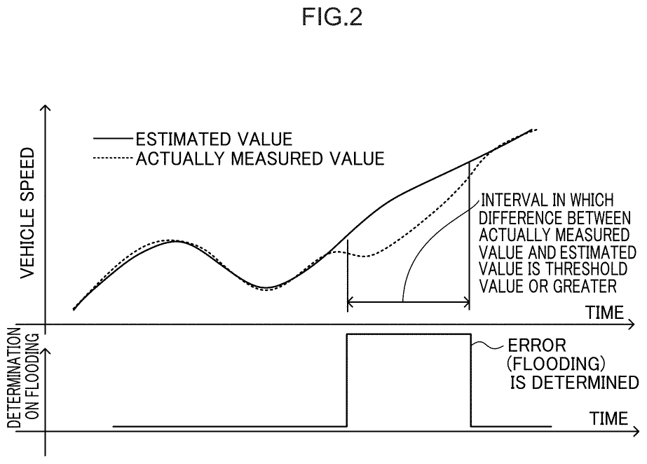

The determining section 42 compares the vehicle speed predicted by the prediction section 40 with the actual vehicle speed acquired from the information providing device 14 to determine whether or not the road is flooded. Specifically, when the difference between the predicted value and the actual measured value is equal to or larger than a predetermined threshold value, it is determined that there is flood, thereby detecting flooding of the road. For example, as shown in FIG. 2, when the measured value and the predicted value change with the passage of time, in a section in which a state where the difference between the measured value and the predicted value is equal to or larger than a predetermined threshold continues for a predetermined period of time, the determining section 42 determines that there is an error, that is, flooding. The predetermined time is, for example, 5 seconds or more.

The flooded area prediction section 44 estimates the flooded area where the road is flooded, using the determination result of the determination section 42. For example, the flooded area prediction section 44 divides the map into 100 m square sections to define an area, and collects the determination results from the determining section 42 of individual vehicles. Next, in a certain area, when there is a predetermined number or more determinations of flooding within a predetermined time, the flooded area prediction section 44 predicts that area as a flooded area.

The model updating section 46 uses the CAN data stored in the CAN database 52 to derive the coefficients of the vehicle behavior model by machine learning, stores the coefficients in the model storage section 50, and updates the coefficient table of the model as needed.

Next, an example of the above-described vehicle behavior model for obtaining the vehicle speed will be described in detail. In the present exemplary embodiment, a vehicle behavior model that determines the vehicle speed as a physical quantity using a motion equation is derived.

First, the motion equation can be expressed by the following equation (1).

M×(dv/dt)=F (1)

Note that M is the vehicle weight, dv/dt is the acceleration, and F is the force by which the vehicle 12 moves forward.

Here, dv/dt can be approximately expressed by the following equation (2).

dv/dt=(v(t+Δt)−(v(t))/Δt (2)

Note that v (t+Δt) is the vehicle speed (predicted vehicle speed) after Δt seconds, t is time, and v (t) is the vehicle speed at the current time.

By substituting equation (2) into equation (1), the following equation (3) is obtained.

M×(v(t+Δt)−v(t))/Δt=F (3)

When rearranging v (t+Δt), the following equation (4) is obtained.

v(t+Δt)=v(t)+(F/M)×Δt (4)

Here, the item F is F=F1 (driving force of the vehicle 12)−F2 (resistance received by the vehicle 12), and when CAN data is used,

F1=C1×R (5)

Note that Cl is a coefficient and R is an accelerator depression amount, which is obtained from the CAN data.

F2=air resistance+gradient resistance+rolling resistance+acceleration resistance (6)

Air resistance=C21×v (t)²

Gradient resistance=C22×sin θ

Rolling resistance=C23×v (t)

Acceleration resistance=C24×a (t)

C21, C22, C23, and C24 are coefficients, θ is a road surface gradient, v (t) is a vehicle speed, and a (t) is an acceleration, which are obtained from CAN data.

By substituting equations (5) and (6) into equation (4), the following multiple regression equation can be obtained as a vehicle behavior model.

v(t+Δt)=v(t)+{C1×R−(C21×v(t)²+C22×sin θ+C23×v(t)+C24×a(t))}×(Δt/M) (7)

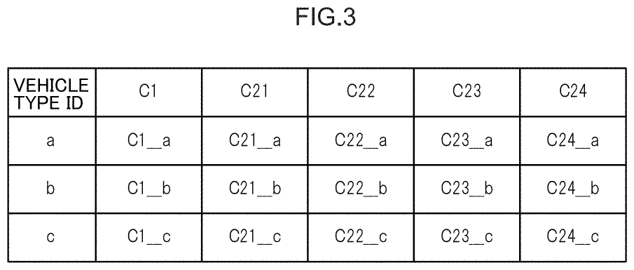

Each coefficient is obtained by a learning model of multiple regression analysis using a large amount of CAN data collected from the plural vehicles 12 and stored in a CAN database, and is stored in the model storage section 50 as a coefficient table. Further, every time the CAN data is newly acquired, the coefficients stored in the model storage section 50 are updated. Further, since the coefficients differ for each vehicle type, the coefficients are obtained and updated for each vehicle type. For example, as shown in FIG. 3, the coefficients stored in the model storage section 50 are stored as a table in which the vehicle model and the model coefficients are associated with each other.

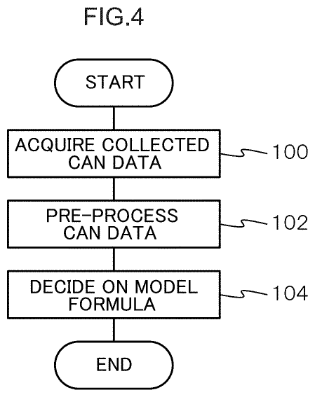

Next, in the flood sensing system 10 according to the present embodiment configured as described above, a process when the central processing section 38 derives a vehicle behavior model in the flood area prediction center 36 will be described. FIG. 4 is a flowchart illustrating an example of a flow of processing performed by the central processing section 38 when a vehicle behavior model is derived by machine learning in the flooded area prediction center 36 of the flooded water sensing system 10 according to the present exemplary embodiment. The processing of FIG. 4 is performed when deriving the initial coefficients of the vehicle behavior model, and is performed every time the CAN data is collected in the CAN database 52.

In step 100, the model updating section 46 acquires CAN data as running state data collected in the CAN database 52 via the central communication section 48, and proceeds to step 102. Step 100 corresponds to an acquisition section.

In step 102, the model updating section 46 performs preprocessing on the acquired CAN data, and proceeds to step 104. As the pre-processing, for example, the CAN data is sorted by date and time and by vehicle type, and classified by time and by vehicle type. In addition, processing such as interpolation may be performed on data loss by unifying the time for each item of CAN data.

In step 104, the model updating section 46 determines the model formula, stores it in the model storage section 50, and ends the processing. That is, using the CAN data, each coefficient of the multiple regression equation as the above-described vehicle behavior model is derived by machine learning and stored in the model storage section 50. If each coefficient has already been stored, each coefficient is updated. Step 104 corresponds to a derivation section.

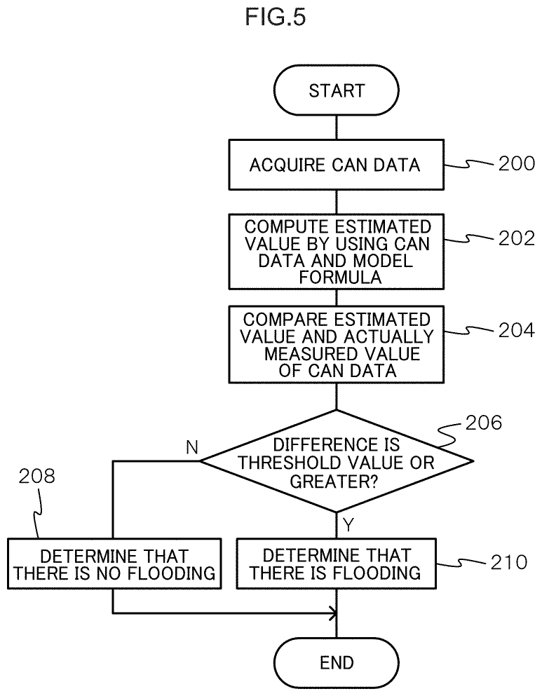

Next, a process performed when the central processing section 38 in the flooding area prediction center 36 determines flooding based on CAN data from each vehicle 12 will be described. FIG. 5 is a flowchart illustrating an example of a flow of processing performed by a central processing section 38 when a flood is determined in the flood area prediction center 36 of the flood sensing system 10 according to the present exemplary embodiment. The process in FIG. 5 is started, for example, every time CAN data is acquired from the information providing device 14 of each vehicle 12 or every time a predetermined amount of CAN data is acquired.

In step 200, the central processing section 38 acquires CAN data from the information providing device 14 via the central communication section 48 and the communication network 34, and proceeds to step 202. Step 200 corresponds to an acquisition section, and the subsequent processing of steps 202 to 210 corresponds to a detection section.

In step 202, the estimation section 40 calculates a predicted value of the vehicle speed using the acquired CAN data and the vehicle behavior model, and proceeds to step 204. That is, the vehicle behavior model stored in the model storage section 50 is read, the vehicle type is specified from the vehicle type ID, a coefficient corresponding to the vehicle type is selected, and the coefficient is applied to the vehicle behavior model. Then, a predicted value of the vehicle speed is calculated by substituting the acquired CAN data into the vehicle behavior model.

In step 204, the determining section 42 compares the predicted value of the vehicle speed with the actually measured value of the vehicle speed of the actual CAN data acquired from the information providing device 14, and proceeds to step 206.

In step 206, the determination section 42 determines whether the difference between the predicted value and the actually measured value is equal to or greater than a predetermined threshold. When the determination is negative, the process proceeds to step 208, and when the determination is affirmative, the process proceeds to step 210.

In step 208, the determination section 42 determines that the road on which the vehicle 12, from which the CAN data has been acquired, is not flooded, and ends the processing.

On the other hand, in step 210, the determination section 42 determines that the road on which the vehicle 12, from which the CAN data has been acquired, is flooded, and ends the processing.

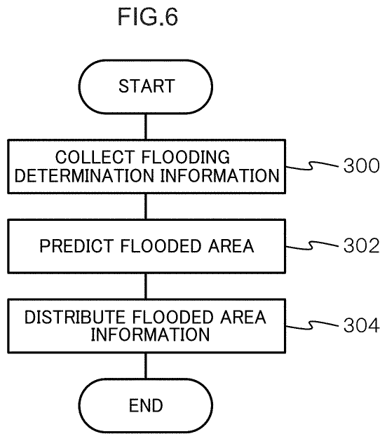

Next, in the flood sensing system 10 according to the present embodiment, a process in which the central processing section 38 in the flood area prediction center 36 estimates a flood area will be described. FIG. 6 is a flowchart illustrating an example of a flow of processing in which a central processing section 38 estimates a flooded area in a flooded area prediction center 36 in the flooded water sensing system 10 according to the present exemplary embodiment.

In step 300, the flooded area prediction section 44 collects the flooded water determination information, and proceeds to step 302. That is, the result of the flood judgment in FIG. 5 is collected. Step 300 corresponds to a result collection section.

In step 302, the flooded area prediction section 44 estimates the flooded water area, and proceeds to step 304. The flooded area prediction section 44 predicts the flooded area where the road is flooded, using the determination result of the determination section 42 as discussed above. For example, an area is defined by dividing the map into 100 m square sections, the determination results of the determination section 42 in individual vehicles are collected, and when there is determination of flooding a predetermined number of times or more within a predetermined time period in a certain area, this area is predicted as the flooded area. Step 302 corresponds to an estimation section.

In step 304, the flooded area prediction section 44 distributes the flooded area information, and ends the processing. For example, by distributing the flooded area information to the information providing apparatus 14 connected to the communication network 34 via the central communication section 48, the flooded area can be made known to each vehicle 12 equipped with an information providing apparatus 14. Thus, each vehicle 12 equipped with an information providing device 14 can select a route that does not pass through the flooded area. For example, when route guidance through the flooded area is performed by a navigation device, it is possible to reroute to a route that avoids the flooded area. Alternatively, a fee may be obtained by distributing the flooded area information to a weather forecasting company or the like in need thereof.

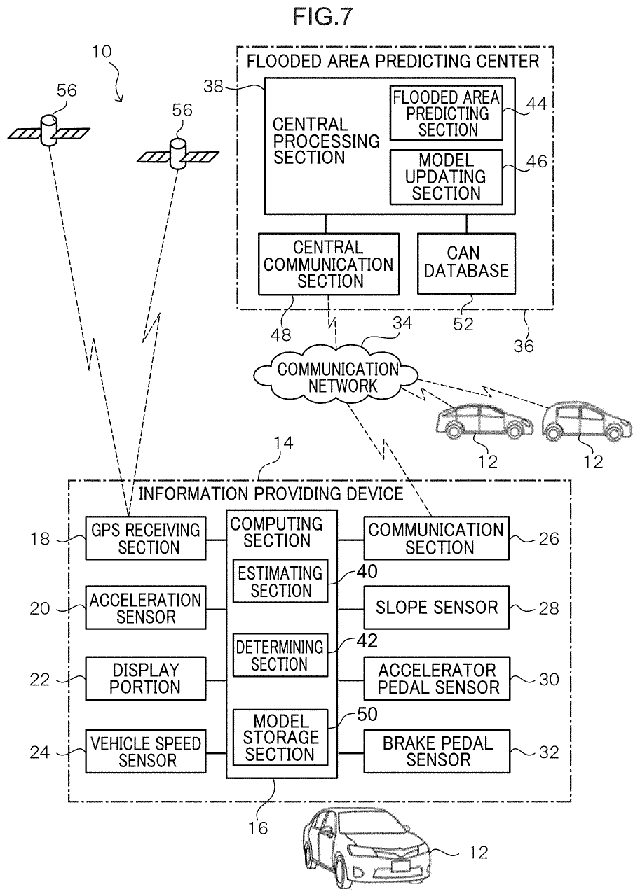

In the above-described exemplary embodiment, an example is described in which the flooding area prediction center 36 performs the flooding determination. However, the present invention is not limited to this. For example, the flood determination may be performed by the information providing device 14 mounted on each vehicle 12. FIG. 7 is a block diagram showing a configuration example of a flood sensing system in a case where the flood determination is performed at the side of the information providing device 14 mounted on each vehicle 12. In this case, as shown in FIG. 7, the functions of the prediction section 40, the determining section 42, and the model storage section 50 are provided to the information providing apparatus 14. That is, the model storage section 50 derives and stores in advance a vehicle behavior model corresponding to the type of the vehicle 12 on which the information providing device 14 is mounted. Alternatively, plural vehicle behavior models for each vehicle type are derived and stored in advance, and a vehicle behavior model corresponding to the own vehicle is selected when used. Then, the computing section 16 of the information providing device 14 executes the processing of FIG. 5, whereby the prediction value is calculated by the estimating section 40 and the flooding determination by the determining section 42 can be performed in the same manner as in the above-described exemplary embodiment. When estimating the flooded area, the central processing section 38 of the flooded area prediction center 36 collects the flooding determination result from each vehicle 12 and performs the processing in FIG. 6, whereby the flooded area can be estimated by the flooded area prediction center 36. When the flooding determination is performed by the information providing device 14 mounted on each vehicle 12, the processing in FIG. 5 is appropriately converted to processing performed by the computing section 16 and is performed. In this case, the processing of step 200 executed by the computing section 16 corresponds to an acquisition section, and the processing of steps 202 to 210 corresponds to a detection section.

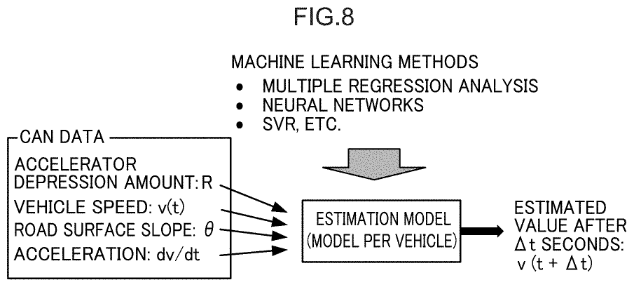

In the above-described exemplary embodiment, an example in which a multiple regression equation is used as a vehicle behavior model has been described. However, the vehicle behavior model is not limited to machine learning using a multiple regression equation. For example, as shown in FIG. 8, the vehicle behavior model uses CAN data (accelerator depression amount R, vehicle speed v (t), road surface gradient θ, acceleration dv/dt, etc.) for each item of the explanatory variables of the prediction equation. Various prediction models for calculating the prediction value v (t+Δt) after Δt seconds can be applied. As an example of the prediction model other than the multiple regression analysis, various machine learning models such as a neural network and a support vector regression (SVR) may be applied.

Further, in the above-described exemplary embodiment, the vehicle behavior model that determines the vehicle speed as the physical quantity is used. However, the physical quantity is not limited to the above described examples. For example, the vehicle behavior model that determines another physical quantity such as acceleration or the rate of change of acceleration may be used.

Further, in the above-described exemplary embodiment, the vehicle behavior model is derived in which the resistance F2 that the vehicle receives is the air resistance, the gradient resistance, the rolling resistance, and the acceleration resistance, but the resistance F2 that the vehicle receives is not limited the above described examples. For example, since the acceleration resistance is smaller than other resistances, the acceleration resistance may be omitted.

Further, the processing performed by each part of the flooding sensing system 10 in each of the above-described exemplary embodiments has been described as software processing performed by executing a program, but it is not limited thereto. For example, the processing may be performed by hardware. Alternatively, the processing may be a combination of both software and hardware. In the case of software processing, the program may be stored in various kinds of storage media and distributed.

The present disclosure is not limited by the foregoing description. In addition to the foregoing description, it will be clear that modifications may be embodied within a technical scope not departing from the gist of the disclosure.

What is claimed is:

1. A flooding sensing device, comprising:
an acquisition section configured to acquire vehicle model information and a plurality of items of travel state data related to travel of a vehicle; and
a detection section configured to select a vehicle behavior model from a plurality of vehicle behavior models that are derived in advance for each vehicle model, the vehicle behavior model corresponding to the vehicle model information and calculates a physical quantity that changes in accordance with travel by the vehicle, the detection section detects flooding of a road on which the vehicle travels, using the physical quantity, which is predicted based on the selected vehicle behavior model and on the current plurality of items of travel state data acquired by the acquisition section, and using the physical quantity, which is obtained from the current plurality of items of travel state data acquired by the acquisition section.

2. The flooding sensing device of claim 1, wherein the vehicle behavior model is configured by vehicle drive power and by travel resistance including air resistance acting on the vehicle, gradient resistance acting on the vehicle, and rolling resistance acting on the vehicle.

3. The flooding sensing device of claim 2, wherein the travel resistance further includes acceleration resistance acting on the vehicle.

4. The flooding sensing device of claim 1, wherein the detection section detects flooding in a case in which a difference between the predicted physical quantity and the physical quantity obtained from the travel state data is equal to or higher than a predetermined threshold value.

5. The flooding sensing device of claim 1, wherein the vehicle behavior model is derived using a multiple regression equation as a learning model.

6. The flooding sensing device of claim 1, wherein the vehicle behavior model is derived with vehicle speed, acceleration, or rate of change of acceleration as the physical quantity and using a motion equation.

7. A flooding sensing device, comprising:
an acquisition section configured to acquire a plurality of items of travel state data related to travel of a vehicle; and
a detection section configured to detect flooding of a road on which the vehicle travels, using a physical quantity, which is predicted based on a vehicle behavior model that is derived in advance in accordance with a vehicle model and that calculates the physical quantity, which changes in accordance with travel by the vehicle, and based on the current plurality of items of travel state data, and using the physical quantity, which is obtained from the current plurality of items of travel state data.

8. The flooding sensing device of claim 7, wherein the vehicle behavior model is configured by vehicle drive power and by travel resistance including air resistance acting on the vehicle, gradient resistance acting on the vehicle, and rolling resistance acting on the vehicle.

9. The flooding sensing device of claim 8, wherein the travel resistance further includes acceleration resistance acting on the vehicle.

10. The flooding sensing device of claim 7, wherein the detection section detects flooding in a case in which a difference between the predicted physical quantity and the physical quantity obtained from the travel state data is equal to or higher than a predetermined threshold value.

11. The flooding sensing device of claim 7, wherein the vehicle behavior model is derived using a multiple regression equation as a learning model.

12. The flooding sensing device of claim 7, wherein the vehicle behavior model is derived with vehicle speed, acceleration, or rate of change of acceleration as the physical quantity and using a motion equation.

13. A flooding sensing device, comprising:
an acquisition section configured to acquire vehicle model information and a plurality of items of travel state data related to travel of a vehicle; and
a derivation section configured to derive a vehicle behavior model, which calculates a physical quantity that changes in accordance with travel by the vehicle, for each vehicle model using the plurality of items of travel state data, acquired in advance from a plurality of vehicles, and using a predetermined learning model; and
a detection section configured to detect flooding of a road on which a target vehicle travels, using the physical quantity, which is predicted using the vehicle behavior model for a vehicle model corresponding to the vehicle model information of the monitored vehicle, which is determined in advance from the vehicle behavior model derived by the derivation section, and is predicted using the current plurality of items of travel state data acquired from the target vehicle, and using the physical quantity, which is obtained from the travel state data acquired from the target vehicle.

14. The flooding sensing device of claim 13, wherein the vehicle behavior model is configured by vehicle drive power and by travel resistance including air resistance acting on the vehicle, gradient resistance acting on the vehicle, and rolling resistance acting on the vehicle.

15. The flooding sensing device of claim 14, wherein the travel resistance further includes acceleration resistance acting on the vehicle.

16. The flooding sensing device of claim 13, wherein the detection section detects flooding in a case in which a difference between the predicted physical quantity and the physical quantity obtained from the travel state data is equal to or higher than a predetermined threshold value.

17. The flooding sensing device of claim 13, wherein the vehicle behavior model is derived using a multiple regression equation as a learning model.

18. The flooding sensing device of claim 13, wherein the vehicle behavior model is derived with vehicle speed, acceleration, or rate of change of acceleration as the physical quantity and using a motion equation.

19. A flooding sensing system, comprising:
a retrieval section configured to retrieve a plurality of items of travel state data related to travel of a vehicle;
an acquisition section configured to acquire the plurality of items of travel state data retrieved by the retrieval section and vehicle model information from a plurality of vehicles;
a derivation section configured to derive a vehicle behavior model, which calculates a physical quantity that changes in accordance with travel by the vehicle, for each vehicle model using the plurality of items of travel state data, acquired in advance by the acquisition section from the plurality of vehicles, and using a predetermined learning model; and
a detection section configured to detect flooding of a road on which a target vehicle travels, using the physical quantity, which is predicted using the vehicle behavior model for a vehicle model corresponding to the vehicle model information of the target vehicle, which is determined in advance from the vehicle behavior model derived by the derivation section, and is predicted using the current plurality of items of travel state data acquired by the acquisition section from the target vehicle, and using the physical quantity, which is obtained from the current travel state data acquired from the target vehicle.

20. The flooding sensing system of claim 19, further comprising:
a result collection section configured to collect detection results of the detection section relative to a plurality of vehicles; and
an estimation section configured to estimate a flooded area based on the detection results collected by the result collection section.

21. The flooding sensing system of claim 20, further comprising a distribution section that is configured to distribute estimation results of the estimation section.

22. A non-transitory computer-readable medium storing a flooding sensing program that causes a computer to function as the respective sections of the flooding sensing device of any one of claim 1.
